(19) United States
(12) Patent Application Publication
(10) Pub. No.: US 2006/0264330 A1
(43) Pub. Date: Nov. 23, 2006

(54) Agricultural agents containing copolymers

(76) Inventors: Ralf Zerrer, Karlstein (DE); Franz-Xaver Scherl, Burgkirchen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/546,504

(22) PCT Filed: Feb. 13, 2004
(86) PCT No.: PCT/EP04/01350

§ 371 Date: Jul. 10, 2006

(30) Foreign Application Priority Data
Feb. 20, 2003 (DE) 103 07 171.7

(51) Int. Cl. A01N 25/10

(52) U.S. Cl. 504/360

(57) ABSTRACT

The present invention relates to agricultural compositions comprising:
A) a pesticide or a plant growth regulator B) a copolymer made of a) a polyglycerol ether b) one or more dicarboxylic acid(s) and/or polycarboxylic acids, wherein the polyglycerol ethers being defined by the formula (I) 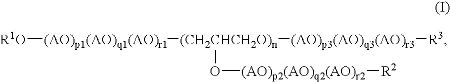
wherein the radicals R¹, R² and R³ are independently identical or different and represent hydrogen; (C₁-C₃₀)-alkyl which is optionally substituted by 1 to 3 (C₁-C₄)-alkyl or (C₁-C₄)-alkoxy groups; (C₂-C₃₀)-alkenyl which is optionally sulfonated and optionally substituted by 1 to 3 (C₁-C₄)-alkyl or (C₁-C₄)-alkoxy groups; phenyl which is optionally substituted by 1 to 3 (C₁-C₄)-alkyl or (C₁-C₄)-alkoxy groups; naphthyl which is optionally substituted by 1 to 3 (C₁-C₄)-alkyl or (C₁-C₄)-alkoxy groups; groups of the formulae R⁴R⁵N—(CH₂)_{y}—; HO—(CH₂)_{y}—; -(AO)_{z}H; —SO₃H; —SO₃⁻X⁺; —PO₃H₂; —PO₃²⁻X⁺; —CR₂—COOR′; —CR₂—COO⁻X⁺; —CO—R⁶—COOH; —CO—R⁶—COO⁻X⁺; —C(R)₂C(R)₂C(R)₂—N(R)₂; —C(R)₂C(R)₂C(R)₂—N((AO)_{z}H)₂; —[CH₂CH(O(AO)_{z}H)CH₂O]ₙ—R¹; where R represents H and/or C₁-C₄-alkyl; R′ represents H or (C₁-C₁₀)-alkyl, (C₂-C₃₀)-alkenyl, optionally sulfonated; R⁴ and R⁵, which can be identical or different, represent hydrogen, (C₁-C₁₀)-alkyl, (C₂-C₃₀)-alkenyl, optionally sulfonated, or a group of the formula -(AO)_{z}H; R⁶ represents (C₁-C₁₀)-alkylene, (C₂-C₃₀)-alkenylene, optionally sulfonated; X⁺ represents Na⁺, K⁺, Ca²⁺ or N(R⁷)₄⁺, where R⁷ represents H or (C₁-C₁₀)-alkyl, preferably (C₁-C₄)-alkyl; x represents a number from 0 to 15; y represents a number from 4 to 6; z represents a number from 0 to 30, preferably 1 to 5; A represents an alkylene group, preferably a group —C₂H₄—, —C₃H₆— or —C₄H₈—; n represents a number from 4 to 40, preferably 5 to 20, in particular 10 to 20; and the indices p1, q1, r1, p2, q2, r2, p3, q3 and r3 represent numbers from 0 to 500; with the proviso that the compounds of the formula (I) comprise free OH groups, and at least one of the radicals R¹, R² and R³ represents a hydrocarbon group, preferably (C₁-C₃₀)-alkyl.

The invention relates to agricultural compositions comprising copolymers which are obtainable by copolymerization of glycerol ethers and dicarboxylic acids or polycarboxylic acids. The copolymers bring about an improved biological activity of plant growth regulators and pesticides (herbicides, insecticides, fungicides, bactericides, molluscides, nematicides and rodenticides).

Plant growth regulators govern physiological reactions such as growth, flowering rhythm, cell division and seed maturation.

Crop protection agents are chemical or natural substances which penetrate plant cells, plant tissue or parasitic organisms in or on the plant and damage and/or destroy them. Most of the pesticides are herbicides, followed by insecticides and fungicides. The most important herbicides are chemical substances which act on the transport system of plants, for example by an inhibition of photosynthesis, fatty acid biosynthesis or amino acid biosynthesis, and lead to the inhibition of germination and growth or to the death of the plants.

The biological activity of a plant growth regulator or pesticide can be determined with reference to the plant growth, or the damage of the plants caused by the action of the active ingredient on the leaf as a function of the exposure time and the effective concentration.

To display an optimal pesticidal activity, the pesticide must wet the chlorophyll and remain there for a sufficiently long period, or penetration of the active substance through the leaf surface must be achieved. A general problem in this context is that only a fraction of the active ingredient exerts the desired activity, i.e. can be applied to harmful plants and grasses and adhere thereto for a sufficiently long period in order to penetrate the plant cells. The greatest part by far is lost and remains unused.

As is described in a multiplicity of patent specifications, the mostly aqueous pesticide formulations have, in order to compensate for this ecological and economical shortcoming, adjuvants added to them which improve the wettability, the solubility, the emulsifiability or the adsorption behavior of the active substance. Moreover, additives can facilitate and accelerate the penetration of the active substances through the leaf surface into the plant.

DE 3 533 808 describes the preparation of polyglycerol fatty acid esters and their use in plant protection compositions for reducing the surface tension of aqueous compositions.

EP 539 980 likewise discloses polyglycerol fatty acid esters, in particular alkoxylated polyglycerol esters as adjuvants in plant protection compositions.

WO 01/08481 extols the use of polyglycerol derivatives in plant protection compositions and discloses the effect of polyglycerol ester on the herbicidal activity of glyphosate. According to WO 02/089 575 and WO 03/000 055, a further improvement of the activity of plant protection compositions can be obtained by crosslinking polyglycerol esters by means of dicarboxylic acids.

Nevertheless, the potential for the optimal display of the biological activity of pesticides and growth regulators is not fully exploited.

It was therefore an object of developing novel compositions or formulations of growth regulators and pesticides, in particular of herbicides of the class of the N-phosphonomethylglycine (glyphosate) substances, which have an improved activity and which are at the same time economical, simple to handle and well tolerated by humans and the environment. Glyphosate, being a highly environmentally compatible and simultaneously highly effective herbicide with a broad range of applications, is being employed in large amounts in agriculture. Together with wetters, it is preferably applied as water-soluble salt, for example as the alkali metal, ammonium, alkylamine, alkylsulfonium, alkylphosphonium, mono(isopropylammonium), mono(trimethylsulfonium), sulfonylamine or aminoguanidine salt or else as the free acid in aqueous formulations, but also in solid form, to leaves and grasses, where it acts on the transport system of the plants and destroys the latter.

Surprisingly, it has been found that the pesticidal activity of plant protection compositions is markedly improved in comparison with crosslinked polyglycerol esters by the addition of copolymers obtainable by copolymerization of glycerol ethers and dicarboxylic acid(s) or polycarboxylic acids.

The present invention relates to agricultural compositions comprising:

A) a pesticide or a plant growth regulator

B) a copolymer made of

a) a polyglycerol ether
b) one or more dicarboxylic acid(s) and/or polycarboxylic acids,
   the polyglycerol ethers being defined by the formula (I) 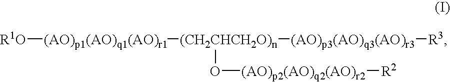
   wherein the radicals R¹, R² and R³ are independently identical or different and represent hydrogen;
   (C₁-C₃₀)-alkyl which is optionally substituted by 1 to 3 (C₁-C₄)-alkyl or (C₁-C₄)-alkoxy groups;
   (C₂-C₃₀)-alkenyl which is optionally sulfonated and optionally substituted by 1 to 3 (C₁-C₄)-alkyl or (C₁-C₄)-alkoxy groups;
   phenyl which is optionally substituted by 1 to 3 (C₁-C₄)-alkyl or (C₁-C₄)-alkoxy groups;
   naphthyl which is optionally substituted by 1 to 3 (C₁-C₄)-alkyl or (C₁-C₄)-alkoxy groups;
   groups of the formulae R⁴R⁵N—(CH₂)_{y}—; HO—(CH₂)_{y}—; -(AO)_{z}H; —SO₃H; —SO₃⁻X⁺; —PO₃H₂; —PO₃²⁻X⁺; —CR₂—COOR′; —CR₂—COO⁻X⁺; —CO—R⁶—COOH; —CO—R⁶—COO⁻X⁺; —C(R)₂C(R)₂C(R)₂—N(R)₂; —C(R)₂C(R)₂C(R)₂—N((AO)_{z}H)₂; —[CH₂CH(O(AO)_{z}H)CH₂O]ₙ—R¹;
   where
   R represents H and/or C₁-C₄-alkyl;
   R′ represents H or (C₁-C₁₀)-alkyl, (C₂-C₃₀)-alkenyl, optionally sulfonated;
   R⁴ and R⁵, which can be identical or different, represent hydrogen, (C₁-C₁₀)-alkyl, (C₂-C₃₀)-alkenyl, optionally sulfonated, or a group of the formula -(AO)_{z}H;
   R⁶ represents (C₁-C₁₀)-alkylene, (C₂-C₃₀)-alkenylene, optionally sulfonated;
   X⁺ represents Na⁺, K⁺, Ca²⁺ or N(R⁷)₄⁺, where R⁷ represents H or (C₁-C₁₀)-alkyl, preferably (C₁-C₄)-alkyl;
   x represents a number from 0 to 15;
   y represents a number from 4 to 6;
   z represents a number from 0 to 30, preferably 1 to 5;
   A represents an alkylene group, preferably a group —C₂H₄—, —C₃H₆— or —C₄H₈—;
   n represents a number from 4 to 40, preferably 5 to 20, in particular 10 to 20;
   and the indices p1, q1, r1, p2, q2, r2, p3, q3 and r3 represent numbers from 0 to 500;
   with the proviso that
   the compounds of the formula (I) comprise free OH groups, and at least one of the radicals R¹, R² and R³ represents a hydrocarbon group, preferably (C₁-C₃₀)-alkyl.

Dicarboxylic acids b) which are preferably employed are dicarboxylic acids of the formula (II)
HOOC—R²—COOH (II)
and/or dicarboxylic acids of the formula (III) 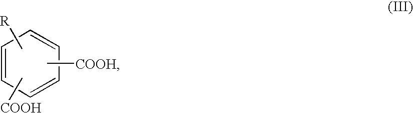
where
R² denotes a (C₁-C₄₀)-alkylene bridge, preferably (C₁-C₁₀)-alkylene, especially preferably (C₁-C₄)-alkylene, or a (C₂-C₂₀)-alkenylene bridge, preferably (C₂-C₆)-alkenylene, especially preferably C₂-alkenylene, and R denotes one or more radicals selected from among H; (C₁-C₂₀)-alkyl, preferably (C₁-C₆)-alkyl, especially preferably (C₁-C₂)-alkyl; (C₂-C₂₀)-alkenyl, preferably (C₂-C₆)-alkenyl; phenyl; benzyl; halogen; —NO₂; (C₁-C₆)-alkoxy; —CHO or —CO((C₁-C₆)-alkyl). R² in formula (II) can be linear or branched. Formula (II) also encompasses dimerized fatty acids such as, for example, the Pripol acids.

Especially preferred as dicarboxylic acids b) are oxalic acid, malonic acid, succinic acid, glutaric acid, adipic acid, pimelic acid, suberic acid, tartaric acid, malic acid, mucic acid, fumaric acid, maleic acid, phthalic acid, isophthalic acid and/or terephthalic acid.

Particularly preferred as dicarboxylic acids b) are phthalic acid, isophthalic acid and/or terephthalic acid.

Very especially preferred as dicarboxylic acid b) is phthalic acid.

Tricarboxylic acids, for example citric acid, dimer fatty acids, trimer fatty acids and polycarboxylic acid can likewise be employed for crosslinking the glycerol units.

In a further preferred embodiment of the invention, the agricultural compositions comprise crosslinked polyglycerol ethers of the formula (I) which comprise —SO₃H, —SO₃⁻X⁺, —PO₃H₂ or —PO₃²⁻X⁺ groups.

The polyglycerol derivatives employed in accordance with the invention as adjuvants in pesticide formulations are obtained by subjecting glycerol to a polycondensation reaction under alkaline conditions, followed by reaction with fatty alcohols and crosslinking with dicarboxylic acids.

To this end, glycerol is heated at 200-280° C. under alkaline conditions. With removal of water of condensation, the polyglycerol with a mean degree of condensation of 3-35 glycerol units is formed within 5 to 15 hours. The resulting polyglycerol is heated for 5 hours to 10 hours with fatty alcohol or fatty alcohol derivatives at 120° C. to 170° C. in the presence of an acidic catalyst, for example sulfuric acid, with removal of water of condensation. The reaction is monitored via the determination of the hydroxyl number which is typically between 400 and 1000 mg KOH/g after the reaction has ended.

The product is subsequently reacted for 1 hour to 3 hours with a dicarboxylic acid at 160° C. to 200° C. to give crosslinked polyglycerol ethers.

In accordance with the invention, it is advantageous to modify polyglycerol ethers before or else after the crosslinking step involving dicarboxylic acids by means of sulfation, phosphation, amination and the like, using standard methods with which the skilled worker is familiar.

After the reaction mixture has cooled to 60-100° C., it is diluted with demineralized water to an active ingredient content of 40-90% and brought to a pH of 6-7 by addition of alkali metal hydroxide.

Especially advantageous are copolymers of polyglycerol with a mean degree of condensation n of from 4 to 20, preferably from 6 to 16, especially preferably from 8 to 10, converted with C₈-C₂₂-fatty alcohols, preferably with C₁₂₋₁₈-fatty alcohols, especially preferably with C₁₂₋₁₄-fatty alcohols, crosslinked with phthalic acid. In an especially preferred embodiment, free OH groups of the crosslinked polyglycerol ethers are fully or partially sulfated, sulfonated or phosphated.

The copolymers preferably comprise form 0.1 to 30% by weight of structural units derived from component b), and structural units from component a) to make 100% by weight.

The viscosity of the pure copolymers measured at 60° C. using a rotational viscometer preferably amounts to from 1000 mPas to 35 000 mPas, especially preferably to from 1500 mPas to 35 000 mPas, particularly preferably to from 1500 to 10 000 mPas, very especially preferably to from 1500 to 7500 mPas. While higher viscosities are possible, they make the handling of the substances more difficult. The copolymers are advantageously handled as 75% to 90% by weight strength aqueous solution.

As the result of this preparation method, the polyglycerol ethers employed in accordance with the invention take the form of mixtures of compounds of the abovementioned formula with different values for n, including unreacted glycerol.

Pesticide preparations comprising polyglycerol mixtures, polyglycerol/polyglycerol derivative mixtures and/or polyglycerol derivative mixtures are also considered as being in accordance with the invention.

The highly concentrated aqueous formulations of anionic pesticides, in particular glyphosate in salt form, and crosslinked polyglycerol ethers are phase-stable. The ionic components do not crystallize out upon addition of polyglycerol ethers, even upon prolonged storage. Besides the high stability to electrolytes, the polyglycerol ethers employed in accordance with the invention are highly stable to hydrolysis and show an improved compatibility of the hydrophilic active ingredient with the plant's lipophilic epidermis, and an improved ability of the former to contact the latter. A good wettability of, and absorption capacity for, the pesticide formulation according to the invention enhances the biological activity of the active ingredients in the plants.

In accordance with the invention, the polyglycerol ethers are suitable as adjuvant in pesticide formulations for improving the biological activity of herbicides, insecticides, fungicides, acaricides, bactericides, molluscides, nematicides and rodenticides, but also for a better performance of plant growth regulators.

In a preferred embodiment, the polyglycerol derivatives are added to herbicide formulations. Suitable herbicides are, in particular, glyphosate, in particular its water-soluble salts, for example as alkali metal, ammonium, alkylamine, alkylsulfonium, alkylphosphonium, mono(isopropylammonium), mono(trimethylsulfonium), sulfonylamine or aminoguanidine salt, without limiting the invention thereto. The following may furthermore be mentioned: acifluorfen, asulam, benazolin, bentazone, bilanafos, bromacil, bromoxynil, chloramben, clopyralid, 2,4-D, 2,4-DB, dalapon, dicamba, dichlorprop, diclofop, endothall, fenac, fenoxaprop, flamprop, fluazifop, flumiclorac, fluoroglycofen, formesafen, fosamine, glufosinate, haloxyfop, imazapic, imazamethabenz, imazamox, imazapyr, imazaquin, imazethapyr, ioxynil, MCPA, MCPB, mecoprop, methylarsonic acid/MSMA, naptalam, picloram, quinclorac, quizalofop, 2,3,6-TBA and TCA.

Examples of advantageous embodiments of the copolymerization reaction are described hereinbelow.

A) Polymerization of Glycerol to Give Oligoglycerols or Polyglycerols:

Glycerol can be polymerized to give olgioglycerols or polyglycerols in a routine procedure in a stirred apparatus equipped with water trap at 240 to 270° C. while passing through nitrogen. The catalyst used is a 50% strength sodium hydroxide solution in a concentration range of from 0.1 to 0.4% by weight. After 5-20 hours, depending on the desired degree of polymerization, the polymerization reaction is stopped. A sample is taken, and the OH number is determined. The OH number can be used for calculating the mean molar mass of the oligoglycerols or polyglycerols. If appropriate, polyglycerols can be alkoxylated by known methods.

B) One-Pot Process with Pre-Polymerized Polyglycerol:

In a stirred vessel equipped with means for azeotropically removing water, the molten polyglycerol is mixed with the dicarboxylic acid or polycarboxylic acid and the fatty alcohol or alkoxylated fatty alcohol, or fatty alcohol derivative, in the desired molar ratio and heated with stirring for 7 hours at 200-240° C.

C) Polyglycerol is First Copolymerized (Crosslinked) with the Dicarboxylic Acid and the Product is then Copolymerized with the Fatty Alcohol, or the Alkoxylated Fatty Alcohol, or the Fatty Alcohol Derivative:

In a stirred vessel equipped with means for azeotropically removing water, the molten polyglycerol is mixed with the dicarboxylic acid or polycarboxylic acid in the desired molar ratio and heated with stirring for 2 hours at 200-240° C. The resulting product is clear and homogeneous. Thereafter, the fatty alcohol, or alkoxylated fatty alcohol, or the fatty alcohol derivative is added and esterified for 5 hours at 200-240° C.

D) Polyglycerol is First Copolymerized with the Fatty Alcohol or Alkoxylated Fatty Alcohol or Fatty Alcohol Derivative and then Copolymerized (Crosslinked) with the Dicarboxylic Acid or Polycarboxylic Acid:

In a stirred vessel equipped with means for azeotropically removing water, the molten polyglycerol is mixed with the fatty alcohol or alkoxylated fatty alcohol or fatty alcohol derivative in the desired molar ratio and heated with stirring for 5 hours at 200-240° C. Thereafter, the dicarboxylic acid or polycarboxylic acid is added in the desired molar ratio and esterified for 2 hours at 200-240° C.

The pesticide preparations according to the invention may comprise the copolymers in virtually any concentration.

Especially preferred as formulations are tank mixes and ready-to-use compositions, which comprise from 0.001 to 10% by weight, preferably from 0.05 to 2% by weight, of pesticide and from 0.01% by weight to 10% by weight, preferably from 0.1% by weight to 2% by weight, especially preferably from 0.2% by weight to 1% by weight, of copolymers. The weight ratio of copolymers to pesticide is preferably between 1:10 and 500:1, especially preferably between 1:4 and 4:1.

Concentrate formulations which are diluted prior to use can comprise the pesticides in amounts of from 5 to 60% by weight, preferably from 20 to 40% by weight, and the copolymers in amounts of from 3 to 50% by weight. The weight ratio of copolymers to pesticide here is preferably between 1:20 and 1:1, preferably 1:10 and 1:2.

As an alternative, the formulations according to the invention can be prepared in solid form as powders, pellets, tablets or granules which are dissolved in water prior to use. Solid preparations can comprise the pesticide in amounts of from 20 to 80% by weight, preferably from 50 to 75% by weight, especially preferably from 60 to 70% by weight, and the copolymers in amounts of from 5 to 50% by weight, preferably from 10 to 30% by weight.

In addition, the pesticide preparations can comprise the customary thickeners, anti-gel agents, antifreeze agents, solvents, dispersants, emulsifiers, preservatives, further adjuvants, binders, antifoam agents, diluents, disintegrants and wetters.

Thickeners which can be used are xanthan gum and/or cellulose, for example carboxycellulose, methylcellulose, ethylcellulose or propylcellulose. The finished compositions preferably comprise from 0.01 to 5% by weight of thickeners. Suitable solvents are monopropylene glycol, animal and mineral oils. Suitable dispersants and emulsifiers are nonionic, amphoteric, cationic and anionic surfactants.

Preservatives can be organic acids and their esters, for example ascorbic acid, ascorbyl palmitate, sorbate, benzoic acid, methyl and propyl 4-hydroxybenzoates, propionates, phenol, for example 2-phenylphenate, 1,2-benzisothiazolin-3-one, formaldehyde, sulfurous acid and its salts.

Suitable antifoams are polysilicones.

Further adjuvants can be alcohol ethoxylates, alkyl polysaccharides, fatty amine ethoxylates, sorbitan ethoxylate derivatives, sorbitol ethoxylate derivatives and derivatives of alk(en)ylsuccinic anhydride. The mixing ratio of these adjuvants to the copolymers is preferably in the range of from 1:10 to 10:1.

Suitable binders for solid formulations are polyvinylpyrrolidone, polyvinyl alcohol, carboxymethylcellulose, sugars, for example sucrose, sorbitol or starch.

Suitable diluents, absorbents or carriers, are carbon black, tallow, kaolin, aluminum stearate, calcium stearate or magnesium stearate, sodium tripolyphosphate, sodium tetraborate, sodium sulfate, silicates and sodium benzoate.

Suitable disintegrants are cellulose, for example carboxymethylcellulose, polyvinylpyrrolidone, sodium acetate or potassium acetate, carbonates, bicarbonates, sesquicarbonates, ammonium sulfate or potassium hydrogen phosphate. Wetters which may be used are alcohol ethoxylates/propoxylates.

The pesticide preparations preferably have a pH of from 4 to 8, especially preferably from 6 to 7.

The formulations according to the invention can be employed in accordance with customary methods.

Aqueous concentrates and solid formulations are diluted with the appropriate amount of water prior to application. From 0.1 to 5 kg, preferably from 0.3 to 2.5 kg of pesticide are preferably applied per hectare. The copolymers preferably amount to 0.1 to 3.0 kg/ha. The spray rate of pesticide preparation is preferably 50 to 1000 l/ha.

The characteristics of the copolymers or pesticide formulations, such as, for example, solubility in water, stability to electrolytes, viscosity and compatibility with plant protectants, can advantageously be adjusted readily via the degree of crosslinking. The nature of, and content in, dicarboxylic or polycarboxylic acid component b) are decisive for the degree of crosslinking, with the content being of particular importance.

Surprisingly, it has been found that highly concentrated aqueous formulations of anionic pesticides, in particular glyphosate in salt form, and copolymers are phase-stable. No crystallization of the ionic components can be observed, even upon prolonged storage. Besides the high stability to electrolytes, the use, according to the invention, of the copolymers brings about an improved compatibility of the hydrophilic active ingredient with the plants' lipophilic epidermis and an improved ability of the former to contact the latter. A good wettability of, and absorption capacity for, the pesticide formulations according to the invention enhances the biological activity of the active ingredient in the plants.

### EXAMPLES

The following text will describe preparation examples of crosslinked polyglycerol ethers, without limiting the invention thereto.

Preparation of Polyglycerol with n=9.7:

In a stirred vessel equipped with means for azeotropically removing water, 2000 g of glycerol and 6.0 g of NaOH (50%) were heated with stirring at 270° C. while passing in nitrogen. After a reaction time of 9 hours and after the removal of 444 g of water, a sample was taken and the OH number was determined. The OH number determined was 892 mg KOH/g. This corresponds to a mean degree of condensation n of 9.7 glycerol units. The degree of condensation can also be determined approximately via the viscosity or the refractive index of the reaction mixture. To this end, a calibration plot must be established beforehand.

Preparation of Copolymer I

180 g of polyglycerol n=9.7 (0.243 mol) were mixed with 24.3 g (0.122 mol) of a C_{12/14} fatty alcohol. 2% by weight of sulfuric acid (50%) were added to act as catalyst. In a stirred vessel equipped with means for azeotropically removing water, the reaction mixture was heated for 7 hours at 150° C., while passing through N₂. Thereafter, 4.03 g (0.024 mol) of phthalic acid were added, and heating was continued for 2 hours at 180° C. The hydroxyl number of the resulting product is 770 mg KOH/g.

Preparation of Copolymer II

180 g of polyglycerol n=9.7 (0.243 mol) were mixed with 48.6 g (0.243 mol) of a C_{12/14} fatty alcohol. 2% by weight of sulfuric acid (50%) were added to act as catalyst. In a stirred vessel equipped with means for azeotropically removing water, the reaction mixture was heated for 7 hours at 150° C., while passing through N₂. Thereafter, 4.03 g (0.024 mol) of phthalic acid were added, and heating was continued for 2 hours at 180° C. The hydroxyl number of the resulting product is 658 mg KOH/g.

Preparation of Copolymer III

In a stirred vessel equipped with reflux condenser and dropping funnel, 215 g of copolymer II (1 mol) were heated at 70° C. A total of 196 g of H₃PO₄ (50%) were added in the course of 2 hours via the dropping funnel. After the addition had ended, the reaction mixture was stirred for a further 8 hours at 100° C.

The examples which follow show the effect of the polyglycerol ethers in comparison with polyglycerol esters on the biological activity of the herbicide glyphosate.

Determination of the foliar uptake of glyphosate with addition of the copolymers described

¹⁴C-Glyphosate Experiment

¹⁴C-glyphosate-IPA at a concentration of 20 mM (aq) (corresponds to 665 g of ae/ha at a spray volume of 200 l/ha) was treated with 0.25% of the copolymers described. Using this mixture, the foliar uptake into the genus Solanum nigrum L. was determined by means of scintillation measurement. The effect of the copolymer on the uptake of the active ingredient via the leaf surface (foliar uptake) is described in the table which follows:

TABLE 1
Effect of copolymers I-V on the herbicidal
effect (Solanum nigrum L.) of glyphosate:

| Adjuvant | Uptake (% of the amount of glyphosate applied) |
|---|---|
| None | 48 |
| Copolymer I | 63 |
| Copolymer II | 50 |
| Copolymer III | 68 |
| Copolymer IV | 56 |
| Copolymer V | 59 |

The foliar uptake of the active ingredient (glyphosate) can be increased significantly in the presence of the crosslinked polyglycerol ethers employed in accordance with the invention, also in comparison with polyglycerol esters.

Preparation of Copolymer IV (PG Ester, not Crosslinked)

A stirred vessel equipped with means for azeotropically removing water and passing through N₂ was charged with 180 g of polyglycerol n=9.7 (0.243 mol), and 24.70 g of coconut fatty acid (0.212 mol) were added. Thereafter, the reaction mixture was heated with stirring for 7 hours at 220° C.

Preparation of Copolymer V (PG Ester, Crosslinked)

A stirred vessel equipped with means for azeotropically removing water and passing through N₂ was charged with 180 g of polyglycerol n=9.7 (0.243 mol), and 24.70 g of coconut fatty acid (0.212 mol) and 10.13 g of phthalic acid (0.061 mol) were added. Thereafter, the reaction mixture was heated with stirring for 7 hours at 220° C.

Bentazone Experiment

The sodium salt of bentazone was applied as an aqueous solution with a concentration of 480 g/l. The application rate was 60 g of ai/ha. The mixture was applied to plants of the genus common lambsquarters (CHEAL) and wild buckwheat (POLCO). The adjuvants were added to the application solution at a concentration of 0.25%. The activity was determined by means of fluorescence measurement, where the factor F_{pc} is a measure of the photosynthetic activity. The destruction of the plant is associated with a drop in the F_{pc} value, starting from 100, down to 0.

TABLE 2
Effect of copolymers I-III on the herbicidal activity
(CHEAL, POLCO) of the sodium salt of bentazone after
1 DAT (DAT: day after treatment) and 60 g/ha

| Adjuvant | Fluorescence F_{pc} CHEAL | Florescence F_{pc} POLCO |
|---|---|---|
| None | 56 | 46 |
| Copolymer I | 21 | 33 |
| Copolymer II | 18 | 17 |
| Copolymer III | 10 | 12 |
| Untreated | 75 | 72 |

Nicosulforon Experiment

Nicosulforon was applied as an aqueous solution with a concentration of 200 g of ai/ha. The adjuvants were added to the application solution at a concentration of 0.25%. The mixture was applied to plants of the genus velvetleaf (ABUTH), common lambsquarter (CHEAL) and common chickweed (STEME). The efficacy was determined by weighing the plant weight (fresh weight in g) 14 days post-application (14 DAT).

TABLE 3
Effect of copolymers I-III on the herbicidal activity
(ABUTH, CHEAL, STEME) of nicosulforon after 14 DAT (DAT:
day after treatment) in FW (g) (fresh weight)

| Adjuvant | ABUTH | CHEAL | STEME |
|---|---|---|---|
| None | 90 | 88 | 63 |
| Copolymer I | 43 | 18 | 20 |
| Copolymer II | 45 | 18 | 21 |
| Copolymer III | 62 | 38 | 43 |
| Untreated | 100 | 100 | 100 |

1. An agricultural composition comprising
A) a pesticide or a plant growth regulator
B) a copolymer made of
a) a polyglycerol ether
b) one or more dicarboxylic acid(s) and/or polycarboxylic acids, the polyglycerol ethers being defined by the formula (1) 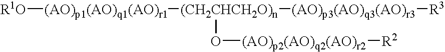
wherein the radicals R¹, R² and R³ are independently identical or different and represent hydrogen;
(C₁-C₃₀)-alkyl which is optionally substituted by 1 to 3 (C₁-C₄)-alkyl or (C₁-C₄)-alkoxy groups;
(C₂-C₃₀)-alkenyl which is optionally sulfonated and optionally substituted by 1 to 3 (C₁-C₄)-alkyl or (C₁-C₄)-alkoxy groups; phenyl which is optionally substituted by 1 to 3 (C₁-C₄)-alkyl or (C₁-C₄)-alkoxy groups;
naphthyl which is optionally substituted by 1 to 3 (C₁-C₄)-alkyl or (C₁-C₄)-alkoxy groups;
groups of the formulae R⁴R⁵N—(CH₂)_{y}—; HO—(CH₂)_{y}—; -(AO)_{z}H; —SO₃H; —SO₃X; —PO₃H₂; —PO₃²⁻X⁺; —CR²—COOR′; —CR²—COO⁻X⁺; —CO—R⁶—COOH; —CO—R⁶—COO⁻X⁺; —C(R)₂C(R)₂C(R)₂—N(R)₂; —C(R)₂C(R)₂C(R)₂—N((AO)_{z}H)₂; —[CH₂CH(O(AO)_{z}H)CH₂O]ₙ—R¹;
where
R represents H and/or C₁-C₄-alkyl;
R′ represents H or (C₁-C₁₀)-alkyl, (C₂-C₃₀)-alkenyl, optionally sulfonated;
R⁴ and R⁵, which can be identical or different, represent hydrogen, (C₁-C₁₀)-alkyl, (C₂-C₃₀)-alkenyl, optionally sulfonated, or a group of the formula -(AO)_{z}H;
R⁶ represents (C₁-C₁₀)-alkylene, (C₂-C₃₀)-alkenylene, optionally sulfonated;
X⁺ represents Na⁺, K⁺, Ca²⁺ or N(R⁷)₄⁺, where R⁷ represents H or (C₁-C₁₀)-alkyl, or a mixture thereof;
x represents a number from 0 to 15;
y represents a number from 4 to 6;
z represents a number from 0 to 30;
A represents an alkylene group, preferably a group;
n represents a number from 4 to 40;
and the indices p1, q1, r1, p2, q2, r2, p3, q3 and r3 represent numbers from 0 to 500;
with the proviso that the compounds of the formula (I) comprise free OH groups, and at least one of the radicals R¹, R² and R³ represents a hydrocarbon group.

2. The agricultural composition as claimed in claim 1, wherein the pesticide is glyphosate.

3. The agricultural composition as claimed in claim 1, comprising
crosslinked polyglycerol ethers of the formula (I) from claim 1, comprising —SO₃H, —SO₃⁻X⁺, —PO₃H₂ or —PO₃²⁻X⁺ groups.

4. The agricultural composition of claim 1, wherein R⁷ is (C₁-C₄)-alkyl.

5. The agricultural composition of claim 1, wherein z is from 1 to 5.

6. The agricultural composition of claim 1, wherein A is selected from the group consisting of —C₂H₄—, —C3H₆—, C₄H₈—, and mixtures thereof.

7. The agricultural composition of claim 1, wherein n is from 5 to 20.

8. The agricultural composition of claim 1, wherein n is from 10 to 20.

9. The agricultural composition of claim 1, wherein at least one of the radicals R1, R2, and R3 is (C₁-C₃₀)-alkyl.
